(19) United States
(12) Patent Application Publication
(10) Pub. No.: US 2004/0136177 A1
(43) Pub. Date: Jul. 15, 2004

(54) ULTRAVIOLET ILLUMINATED FLUORESCENT DRINKING VESSEL

(76) Inventors: Edward D. Lewis, Brownsburg, IN (US); Daniel J. Deutsch, Orlando, FL (US)

Correspondence Address: BAHRET & ASSOCIATES, 320 NORTH MERIDIAN STREET, SUITE 512, INDIANAPOLIS, IN, 46204, US

(21) Appl. No.: 10/341,311

(22) Filed: Jan. 13, 2003

(51) Int. Cl. F21V 33/00

(52) U.S. Cl. 362/101; 362/84; 362/260; 362/800

(57) ABSTRACT

An illuminated drinking vessel includes a main body with a side wall having fluorescent pigment. An ultraviolet light-emitting diode illuminates the fluorescent pigment. The drinking vessel includes an electrical power source such as a button cell and an electrical switch for selectively controlling the flow of electrical current between the power source and light-emitting diode. A base member connected to the main body contains the power source, the electrical switch, and the ultraviolet light-emitting diode. The fluorescent pigment of the side wall emits visible light in response to being illuminated by ultraviolet light.

### BACKGROUND OF THE INVENTION

This invention relates to drinking vessels, and particularly to drinking vessels having a self-contained source of illumination.

It is known to provide a drinking vessel with a self-contained source of illumination to light the drinking vessel in the dark. Lighted drinking vessels commonly include a lamp of the light-emitting diode (LED) or incandescent type, a battery, and an electrical switch and circuit to control the flow of current between the battery and the lamp.

Illuminated drinking vessels have been an object of interest for more than fifty years, as exemplified by the following patents:

| Patent No. | Inventor | Issue Date |
|---|---|---|
| 2,224,319 | Schroyer | Dec. 10, 1940 |
| 2,663,866 | Simpson | Aug. 23, 1951 |
| 4,390,928 | Runge | Jun. 28, 1983 |
| 4,922,355 | Dietz et al. | May 1, 1990 |
| 5,070,435 | Weller | Dec. 3, 1991 |
| 5,119,279 | Makowsky | Jun. 2, 1992 |
| 5,211,699 | Tipton | May 18, 1993 |
| 5,339,548 | Russell | Aug. 23, 1994 |
| 5,504,663 | Tucker | Apr. 2, 1996 |

### SUMMARY OF THE INVENTION

The present invention provides an illuminated drinking vessel including a lower wall, and a side wall having fluorescent pigment. An ultraviolet light-emitting diode is proximate the lower wall to illuminate the fluorescent pigment. The drinking vessel further includes an electrical power source and an electrical switch for selectively controlling the flow of electrical current between the power source and light-emitting diode.

Other aspects of the present invention will be apparent from the following description of preferred embodiments with reference to the accompanying drawings.

### BRIEF DESCRIPTION OF THE DRAWINGS

FIG. 1 is a side view of one embodiment of an ultraviolet illuminated drinking vessel with a wall having fluorescent pigment, shown in cross-section.

FIG. 2 is an exploded view of the drinking vessel of FIG. 1.

FIG. 3 is a top view of the printed circuit board shown in FIGS. 1 and 2.

FIG. 4 is an electrical schematic of the flasher circuit in the drinking vessel of FIGS. 1 and 2.

FIG. 5 is a side view of another embodiment of an ultraviolet illuminated drinking vessel with a wall having fluorescent pigment, shown in cross-section.

FIG. 6 is an exploded view of the drinking vessel of FIG. 5.

### DETAILED DESCRIPTION OF THE PREFERRED EMBODIMENT

For the purposes of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device and such further applications of the principles of the invention as illustrated therein being contemplated as would normally occur to one skilled in the art to which the invention relates.

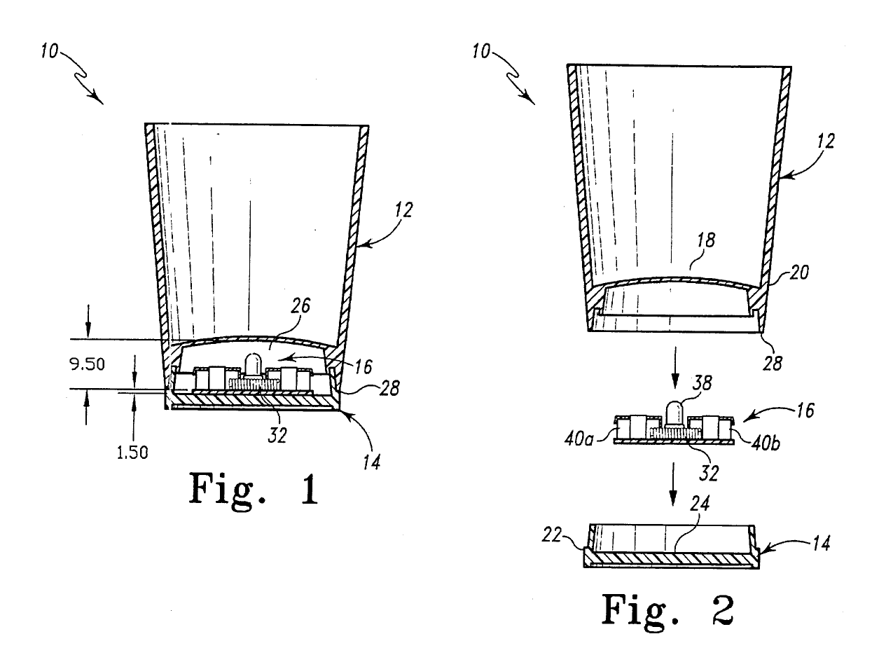

Referring to FIG. 1 as well as to the exploded view of FIG. 2, one embodiment of the present invention is a lighted drinking vessel or shot glass 10 that includes a main body 12 and a base member 14 which are molded separately and which enclose an impact-responsive indicator circuit 16. Main body 12 includes an integral lower wall 18 and side wall 20 that define a receptacle for liquid and that cooperate with base member 14 to form a hollow base. Walls 18 and 20, together with a side wall 22 and a bottom wall 24 of base member 14, define a compartment 26 for the indicator circuit. Main body 12 is frustoconical and base member 14 is generally cylindrical as illustrated, but either one may have either shape. The main body and base member are both preferably molded of high-impact polystyrene. Further details on a shot glass of the type described above may be found in U.S. Pat. Nos. 5,772,065 to Kalamaras, which patent is hereby incorporated by reference.

Main body 12 is constructed of a transparent or translucent molded plastic material and is illuminated by a light source, which may be flashing or blinking, located within base member 14. As preferred, the plastic material of at least side wall 20 and preferably all of main body 12 has fluorescent pigment mixed therein prior to molding. In an alternative configuration that may be desirable for some applications, the fluorescent pigment may be applied as a coating to the outer surface of the side wall 20. The light source within base member 14 is an ultraviolet light emitting diode (UV LED). The ultraviolet light excites the fluorescent pigment and causes the main body 12 to glow, creating a novel and pleasing aesthetic effect, and also illuminating adjacent surfaces in low-light conditions.

The fully assembled shot glass of FIG. 1 has an overall height of about 55-60 mm. As shown in the drawing, the floor of compartment 26 is 1.5 mm below the bottom edge 28 of side wall 20, and the ceiling is 9.5 mm above edge 28, for a total inside height of 11 mm. Although these are the preferred dimensions, it will be understood that some variation thereof is contemplated for any given size of shot glass and that other sizes of shot glasses are contemplated. Indicator circuit 16 in the disclosed embodiment has an overall height of about 8 mm.

The separately molded parts of the shot glass may be adhesively bonded together or may be attached by means of a snap-fit connection. In one form of snap-fit connection, the inner surface of side wall 20 is provided with an annular projection or ridge and the outer surface of side wall 22 is provided with a corresponding annular groove, or vice versa. The ridge may extend completely or partially around the circumference of the side wall 20, and in this case there may be a set of circumferentially spaced ridges. Alternatively, the mating side wall surfaces may both be provided with annular projections adapted to momentarily compress or bend each other as one is forced over the other to snap the two parts of the shot glass together. As another alternative, a set of circumferentially spaced interlocking projections may be provided on each of side walls 20 and 22 and arranged such that the respective projections in each set are offset from each other circumferentially for insertion of the base member into the main body and then rotated with respect to each other in “bayonet” fashion to achieve mutual locking engagement. Although not preferred, the base members may alternatively be joined by ultrasonic welding, in which case energy-directing beads may be required on the mating surfaces as described in the above-referenced U.S. Pat. No. 5,772,065.

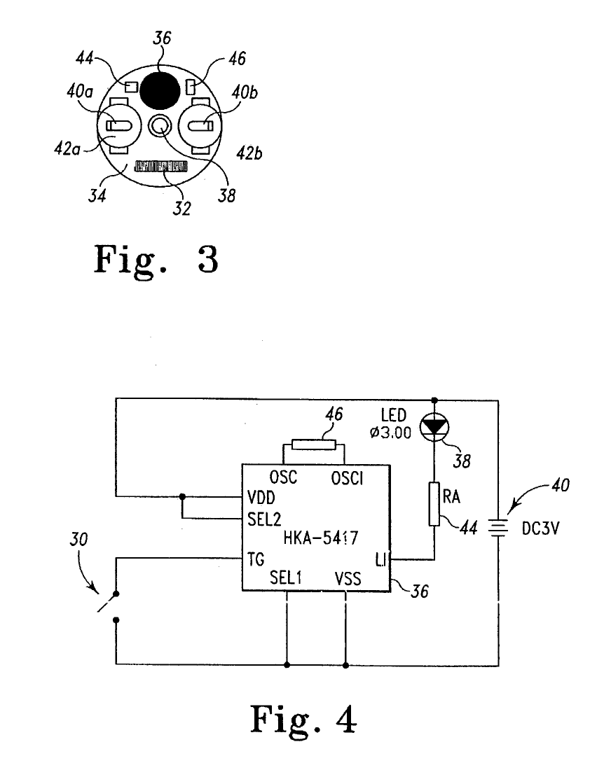

Referring now also to FIGS. 3-4, the indicator circuit in the illustrated embodiment is a flasher circuit and includes a low-profile inertial switch 30 having a cantilevered coil spring contact 32 directly mounted on a printed circuit (pc) board 34 and oriented with the longitudinal axis of the coil spring parallel to the plane of the pc board and perpendicular to the longitudinal axis of the shot glass. The flasher circuit includes inertial switch 30, an integrated circuit (IC) 36, an ultraviolet (UV) LED 38, two button cells 40a,b in respective battery holders 42a,b, and associated resistors 44 and 46, all interconnected as shown in FIG. 3 and all mounted on the circuit board, which may be secured to lower wall 24 by double-backed tape. Suitable dimensions for the pc board are 0.8 mm thickness and 23 mm diameter. The inertial switch as shown is a normally open switch, and IC 36 is triggered by closure of the switch to supply a flashing signal to the UV LED. The IC preferably operates in one-shot mode, whereby it continues to generate an output signal once triggered by the switch, and preferably generates a train of pulses in response to a trigger pulse from the switch.

The IC is preferably supplied in die form and wire bonded to the upper surface of the circuit board. A suitable IC for the flasher circuit is type HKA-5417, also identified as A5417, commercially available from Hua Ko Electronics Co. Ltd., Hong Kong. The IC generates a pulse train of 38 pulses each time it is triggered, at a rate and with a pulse width controlled by timing resistor 46. The timing resistor value is preferably selected so that the IC generates approximately 2 pulses per second with a pulse width of approximately 100 milliseconds. Proportionately different pulse widths and rates may be obtained if desired by selecting a different value for resistor 46. Further details of a suitable circuit design may be found in U.S. Pat. No. 6,419,384 to Lewis et al., which patent is hereby incorporated by reference.

UV LED 38 emits light having a wavelength in the range of about 390 to about 410 nm, more preferably having a peak of about 390 nm to about 410 nm, and most preferably having a peak of about 400 nm. A suitable UV LED is the DL50PLDW503 UV LED available from Shue Kwong Optic Electronic Company, Shenzhen, China. The ultraviolet light is collected by lower wall 18 and transmitted throughout the plastic material that comprises lower wall 18 and side wall 20 of main body 12. The intensity of the illumination may diminish somewhat along the length of side wall 20, due to increased attenuation of the ultraviolet light as it passes through the plastic material, resulting in the brightness of the visible light emitted from side wall 20 diminishing over the length of shot glass 10 toward the rim. The visual effect may be enhanced, if desired, with an upwardly oriented parabolic or otherwise curved reflector around the UV LED. A flat reflector is also useful around the LED.

The above-described combination of a UV LED and fluorescent pigment in a shot glass is particularly advantageous with a dark alcoholic beverage or other liquid in the glass. Dark liquids tend to absorb the light emitted from a light source in the base and thereby degrade the illumination. However, UV light transmits through the dark liquid and/or through the plastic body of the shot glass and, in combination with the fluorescent pigment, causes the side wall to glow and thereby remain highly visible despite the contents of the glass.

The plastic material of side wall 20 and lower wall 18 can be a polycarbonate material that is mixed with fluorescent pigment and injection molded into the shape of shot glass 10. Alternatively, the plastic material may be polystyrene, PVC, ABS or acrylic materials. The pigment may be mixed at a ratio of about 1 to 2 grams of pigment per kilogram of plastic material. The fluorescent pigment may be a pigment that is commercially available from Wen Lee Plastic Pigment Company, Tungguong, China, such as Part No. 61113 (green), Part No. 31461 (blue), Part No. 238 (red), or Part No. 2600 (yellow). As discussed above, in an alternative configuration that may be desirable for some applications, the fluorescent pigments may be applied as a coating to the outer surface of the side wall 20.

An alternative circuit configuration suitable for certain applications including larger drinking vessels such as tumblers is disclosed in copending U.S. patent application Ser. No. 08/730,597 and is incorporated herein by reference. In addition, the invention may alternatively be embodied in plastic mugs and miniature martini glasses.

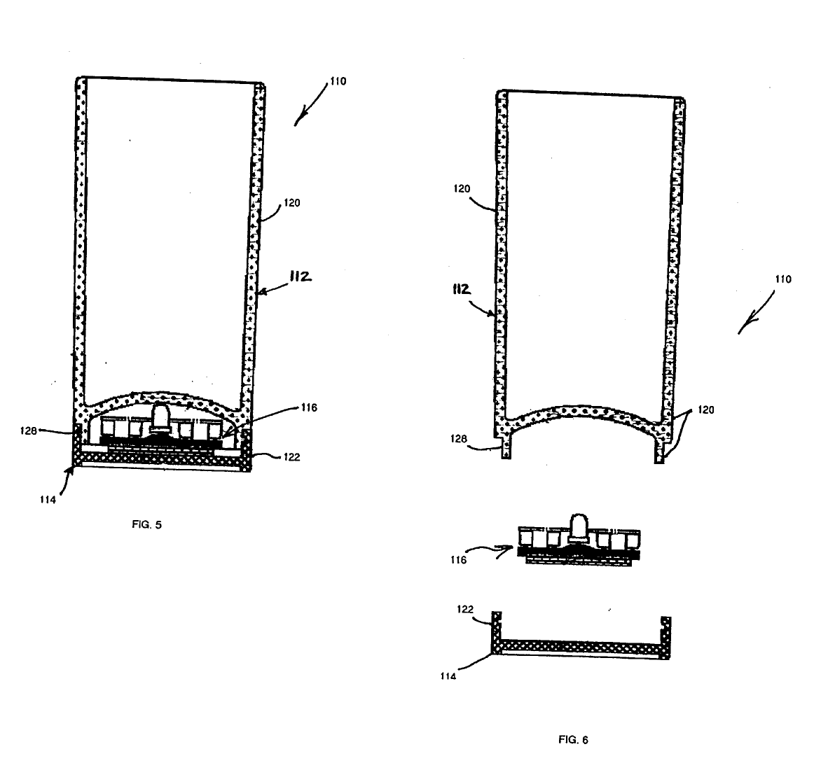

Another embodiment of the present invention is shown in FIGS. 5 and 6 in which drinking vessel or shot glass 110 is similar to shot glass 10 described above, except as further described below. Shot glass 110 has an overall height of about 76 mm and a maximum diameter of about 36 mm, and is frustoconical but with a shallower taper than that of shot glass 10. Main body 112 and base member 114 together enclose an impact-responsive indicator circuit 116 of the same type as circuit 16 described above. Main body 112 is preferably bayonet mounted to base member 114, i.e., by means of a press- and-twist interlocking connection. More specifically, the bottom portion 128 of side wall 120 may have two small projections engaging respective L-shaped grooves formed in the inside surface of side wall 122. Other types of connections as described above for shot glass 10 may be employed as alternatives.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected. For example, it is also contemplated that fluorescein dye may be mixed with ink to be applied to a surface of the main body of the drinking vessel to form a logo or other indicia desired to be illuminated.

What is claimed is:

1. An illuminated drinking vessel, comprising:
a main body including a lower wall and a side wall that define a receptacle for liquid, at least the side wall having fluorescent pigment;
an ultraviolet light-emitting diode proximate the lower wall to illuminate the fluorescent pigment;
an electrical power source; and
an electrical switch for selectively controlling the flow of electrical current between the power source and light-emitting diode.

2. The drinking vessel of claim 1, further including a base member connected to the main body, the base member containing the electrical power source and the electrical switch.

3. The drinking vessel of claim 2, wherein the base member contains the ultraviolet light-emitting diode.

4. The drinking vessel of claim 1, wherein the fluorescent pigment of the side wall emits visible light in response to being illuminated by ultraviolet light from the light-emitting diode.

5. The drinking vessel of claim 1, wherein the ultraviolet light-emitting diode emits light having a peak wavelength in the range of about 390 nm to about 410 nm.

6. The drinking vessel of claim 6, wherein the ultraviolet light-emitting diode emits light having a peak wavelength of about 400 nm.
